(19) United States
(12) Patent Application Publication
(10) Pub. No.: US 2008/0308550 A1
(43) Pub. Date: Dec. 18, 2008

(54) Magnetic flux guide for continuous high frequency welding of closed profiles

(75) Inventor: Valentin Nemkov, White Lake, MI (US)

Correspondence Address: WARN, HOFFMANN, MILLER & LALONE, .P.C, PO BOX 70098, ROCHESTER HILLS, MI, 48307, US

(73) Assignee: Fluxtrol Inc., Auburn Hills, MI (US)

(21) Appl. No.: 12/157,808

(22) Filed: Jun. 13, 2008

Related U.S. Application Data
(60) Provisional application No. 60/934,340, filed on Jun. 13, 2007.

(51) Int. Cl. B23K 13/01

(52) U.S. Cl. 219/607

(57) ABSTRACT

A magnetic flux guide for improvement of continuous induction tube welding process is provided having a magnetic body made from one or several plates of soft magnetic composite (magnetodielectric material) that has permeability of at least 15, saturation flux density greater than about 0.2 T and service temperature of at least 180° C. The device also comprises internal channels for water or gas cooling or one or two water-cooled plates, which are located in the middle of the magnetic body, on one side or both sides of the body. The device preferably has a fixture for its positioning above the edges of the welding tube or profile. The device may be incorporated into the welding coil, which provides to the device mechanical support and cooling.

### CROSS-REFERENCE TO RELATED APPLICATIONS

This application claims the benefit of U.S. Provisional Application No. 60/934,340 filed Jun. 13, 2007.

### FIELD OF THE INVENTION

The present invention relates to continuous high frequency induction welding systems and more particularly to the system performance improvement by control of magnetic flux in an external area of such welding systems.

### BACKGROUND OF THE INVENTION

High frequency (HF) welding is the most popular technique for production of welded metallic tubes, pipes and closed profiles. According to this method HF current is applied to the edges of continuously moving preformed tube (skelp) with opening that must be closed in the process of welding. HF currents flow along the skelp edges in opposite directions on each side of the opening and heat them to or slightly below the tube metal melting temperature. Due to skin and proximity effects the heat sources are concentrated on the facing sides of the edges. Hot edges are squeezed by welding rolls in the apex point forming a continuous welding seam. The frequency in this type of welding is generally between 30 and 1000 kHz with preferred frequency range of 100-400 kHz, and two different techniques are employed.

The first technique is known as high frequency contact welding. In this technique HF current from the generator (HF welder) is supplied to the skelp through the contacts applied to the opposite edges upstream from the apex. One part of supplied current flows along the tube edges in V area (Vee) from the contacts to the apex. This part of the current heats the tube edges. Another portion of the current flows from the first contact to the second one along the inner surface of the skelp. This current known as a leakage current, causes additional losses in the tube wall. Special devices known as impeders are used to reduce this portion of the current. An impeder contains a magnetic core, a casing, a connector to attach the impeder to a holder and for accommodating cooling fluid, and, in some cases, an inlet for shielding gas.

Contact HF welding is widely used for non-closed profiles such as T or H profiles. It is used also for welding tubes, pipes and closed profiles of relatively large size, typically for tubes with diameter above 150 mm. Low life time and sensitivity to the tube surface conditions are the drawbacks of contact welding that limit their application in tube welding.

The second type of high frequency welding is known as high frequency induction welding. In high frequency induction welding, a single or multiple turn coil encircles a rolled tube or profile preform. Compared to the contact welding, the current is not supplied via contacts but induced in the skelp by the magnetic field of the inductor. All induced currents flow under the inductor around the skelp outer diameter and split into three parts when they reach the tube edges. One portion flows along the edges in Vee similar to contact welding. This is a desirable part of the current. The second portion travels from the outer circumference of the tube, across the edges of the tube cut and then along the internal tube circumference from one edge to another. This second portion of the current is similar to corresponding current in conduction welding. Losses due to this portion of the induced current are higher than in the case of conduction welding because the current flows around the tube outer surface under the coil, i.e. its path is much longer. The third portion flows along the edges in direction opposite to tube movement and then finds a close path along the internal surface of the tube from one edge to another. The third portion is only partially useful due to the edge preheating with prevailing negative effect of additional power losses on the outer and inner tube surfaces. Impeders are widely used to reduce the second and third portions of the induced current and maximize the current in Vee and therefore the system efficiency.

Existing induction welding systems do not contain any device for magnetic field control outside of the tube. Magnetic field surrounds the coil and attenuates with a distance from the coil. The part of field generated by the coil portion surrounding the tube is similar to the field of any cylindrical induction heating coil. The second part of the magnetic field, generated by the coil portion above the tube opening and by the induced current, penetrates inside the tube preform through the opening gap, flows along the impeder inside the tube preform, flows back to the outer space through the gap in Vee and returns in the surrounding space around the coil to the initial area. The magnetic field of the second part is stronger than of the first part.

The magnetic field in the external space causes several negative effects. The first effect is undesirable heating of welding rolls located in close proximity to the coil. The second effect is possible interference with the mill structure, measuring and control devices and the body of operators. The third effect is additional reactive power that requires higher current from the supplying circuit and increases losses in its components (busswork, transformer, compensating capacitor battery).

There were attempts to confine the external magnetic field and reduce field intensity in the surrounding space by applying external magnetic flux concentrators onto the induction coil. This method of magnetic flux control is widely used in induction heating, heat treating and brazing systems. Magnetic controller reduces the coil current demand and therefore reactive power, increases induced current and improves the process efficiency. However in induction welding systems, a positive effect of the external concentrator applied to the whole coil length is overcompensated by increased losses in the tube body under the coil and in the induction coil itself. In addition, it is difficult and expensive to manufacture external controllers from traditionally used in tube welding industry magnetic materials (ferrites) because of their poor mechanical properties. For these reasons, external magnetic flux concentrators are not used in the welding industry.

In spite of relatively high electrical efficiency and welding speeds reaching 1000 ft/min for tubes of small diameter, existing induction welding systems have several drawbacks. In addition to negative effects caused by external magnetic fields, heating of the tube edges is non uniform in thickness, which reduces welding speed and efficiency especially for tubes with thick wall; induction coils have high voltage and current and therefore apparent power, which must be supplied by the welder. The edge heating in Vee has limited controllability with the major part of heating power occurring at the final stage of heating, i.e. in close proximity of the apex. Any variation in length of Vee or in convergence angle can cause the welding quality variation. Finally, external magnetic field level in the work place may exceed Maximum Permissible Level and special screens may be necessary in order to meet the health standards.

In view of the foregoing, it would be desirable to provide a device or devices for magnetic field control in the external area of the welding space in order to increase the system efficiency and welding speed, improve welding quality and reduce or eliminate negative effects of the external magnetic field. It would also be desirable to provide such devices particularly suited for operating in the 100-400 kHz frequency range.

### SUMMARY OF THE INVENTION

The above and other objects are provided by the magnetic bridge device of the present invention. The magnetic bridge device of the present invention provides magnetic flux control in the external area of the welding space. The magnetic bridge is a magnetic flux guide, which contains a magnetic body made from one or several plates of soft magnetic composite (magnetodielectric material) that has permeability of at least 15, preferably above 40, saturation flux density above 0.2 Telsa and service temperature of at least 180° C. Preferably, the device also comprises internal channels for water or gas cooling or one or several water-cooled plates, which are located in the middle of the magnetic body, on one side or both sides of the body. The device preferably has a fixture for its positioning above the edges of the welding tube or profile.

The magnetic bridge may be used as a separate device, in addition to the induction coil and impeders traditionally used in the induction welding systems or may be incorporated into the welding coil which provides mechanical support and cooling to the device.

Operation of the present invention, areas of applicability and provided effects will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of a system for high frequency induction welding of tube or pipe employing the magnetic flux guide of the present invention.

FIG. 2 is a longitudinal cross-sectional view of an induction welding system according to the present invention with demonstration of the magnetic flux path.

FIG. 3 is a transversal cross-sectional view of a first embodiment of the magnetic body of the magnetic flux guide according to the present invention.

FIG. 4 is a transversal cross-sectional view of a second embodiment of the magnetic body of the magnetic flux guide according to the present invention.

FIG. 5 is a transversal cross-sectional view of a third embodiment of the magnetic body of the magnetic flux guide according to the present invention.

FIG. 6 is a transversal cross-sectional view of a fourth embodiment of the magnetic body of the magnetic flux guide according to the present invention.

FIG. 7 is a top view of an induction system with magnetic flux guide of the third type according to the present invention.

FIG. 8 is a longitudinal cross-sectional view of an induction system with two-turn induction coil and magnetic flux guide according to the present invention.

FIG. 9 is a longitudinal cross-sectional view of an induction system with three-turn induction coil and reduced magnetic flux guide according to the present invention.

FIG. 10 is a longitudinal cross-sectional view of an induction system with a single turn induction coil and incorporated magnetic flux guide according to the present invention.

FIG. 11 is a longitudinal cross-sectional view of an induction system with a single turn induction coil and incorporated reduced magnetic flux guide according to the present invention.

### DETAILED DESCRIPTION OF THE INVENTION

The following description of the preferred embodiments is merely exemplary in nature and is in no way intended to limit the invention, its application, or uses.

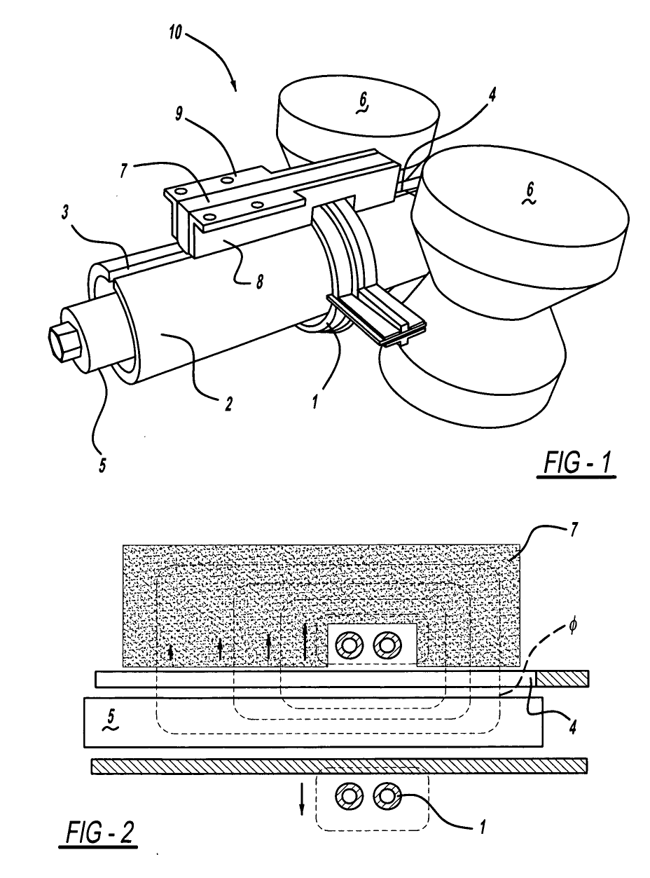

Referring to FIG. 1, a HF induction welding system including a magnetic bridge according to the present invention is generally shown at 10. The induction system includes an induction coil 1 encircling (but not touching) a preformed tube 2. The preform 2 has an opening 3 that converges after passing the coil in the area 4 known as the Vee. The coil generates the magnetic field that induces eddy current in the preform. An impeder 5 is held within the preform 2 in all the length of the welding area up to the end of Vee 4 where the edges converges under the pressure of the welding rolls 6 in the point known as apex. The impeder 5 reduces the induced current flowing from one edge to another along the preform internal surface and forces it to flow along the Vee 4 to the apex. Magnetic bridge has a magnetic body 7 and side cooling plates 8 with connection plates 9 for positioning the device above the preformed tube edges. Though the system of FIG. 1 illustrated as an induction welding system, it should be noted that the magnetic bridge of the present invention is also suitable for use in a conduction welding system. In both cases, the magnetic bridge may be effectively used in combination with impeder or without impeder.

FIG. 2 illustrates how the magnetic bridge reduces magnetic resistance (reluctance) of the area above the edges of opening 3 and the induction coil and thus helps the magnetic flux φ to enter inside the tube preform and to exit from the preform in the Vee. As a result, lower coil current is required for driving the same magnetic flux φ and providing necessary heating of the edges of the opening 3. Magnetic permeability of the magnetic body must be at least 15 and preferably at least 40 to provide maximum possible effect on magnetic flux. Magnetic saturation of the material used in the present invention must be above generally 0.2 Tesla depending on the induction frequency. Typically, magnetic saturation must be above 0.5 and preferably is ≧0.8 T., in order to keep high magnetic permeability at heavy loading typical for welding, especially in lower range of frequencies. As stated above, welding frequencies of 30 kHz to 1 megahertz and typically 100-400 kHz are used. In higher range frequencies approaching 400, the saturation value of the material used may be lower in the aforementioned ranges. Magnetic material of the magnetic bridge is subject to heat by radiation from the hot edges in Vee and from magnetic losses in the material itself. The material must have significant temperature resistance (above 180° C. in long-term service) and high thermal conductivity to transfer losses to the cooling channels or plates. Preferably, magnetiodielectric materials manufactured by Fluxtrol of Auburn Hills, Mich., such is Fluxtrol A, Fluxtrol 75 or other high permeable materials are useful in the present invention.

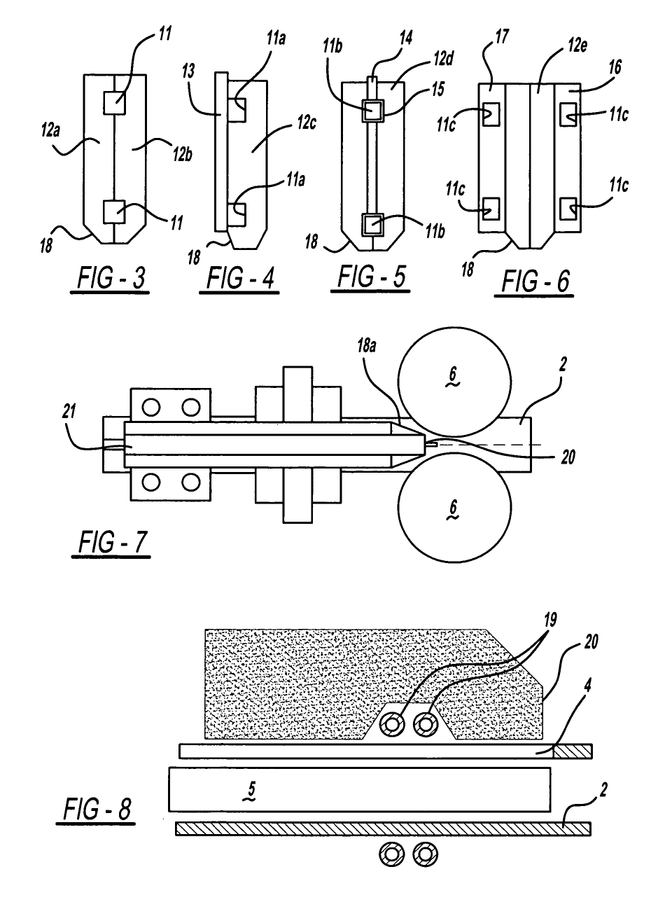

Cooling of the magnetic body 12 of the magnetic bridge may be performed by water, mill water or gas flowing inside the channels 11 in the body 12 as it is shown in FIG. 3. In this case the body 12 is made of two pieces 12a and 12b with milled channels glued one to another.

Referring to FIG. 4, another embodiment of the magnetic body 12c has cooling channels 11a made on one side of the body with a glued lid 13 made of plastic, copper, aluminum and other non-magnetic material.

In cross-section of FIG. 5 the magnetic body 12d is cooled by conduction to the cooling plate 14 placed inside of the magnetic body 12d. Cooling plate 14 may be made from copper, aluminum or other material with high thermal conductivity. The cooling plate includes cooling channels 11b which are formed in the plate 14 or as tubing 15 attached to the plate.

In the magnetic flux guide design shown in FIG. 6, the magnetic body 12e is cooled by conduction to water- or gas cooled plates 16, 17 located on both sides of the magnetic body 12e. These plates 16, 17 may be made from copper, aluminum or other material with high thermal conductivity and include cooling channels for providing cooling to both sides of the magnetic body 12e.

As it is shown in FIG. 3-6, the magnetic body of the magnetic flux guide has preferably a wedged area 18 on the bottom side facing the tube preform for more narrow concentration of magnetic field that exits from the edge opening in the Vee. Because of lower magnetic flux divergence at the exit from the opening, the tube edges are heated more uniformly providing better welding quality and conditions for faster welding.

FIG. 7 shows a top view of the system with magnetic flux guide with a two-side cooling plate configuration. The magnetic flux guide has preferably a wedged end 18a in order to penetrate closer to the apex between the welding rolls.

FIG. 8 shows a longitudinal cross-sectional view of an induction system with two-turn induction coil 19 and the magnetic flux guide according to the present invention. The length of the magnetic body pole 20 above the “Vee” area must be as big as possible in the limited space between the welding rolls 6. The magnetic bridge pole 21 (as shown in FIG. 7) on the opposite side of the welding coil should not preferably extend beyond the area of the impeder.

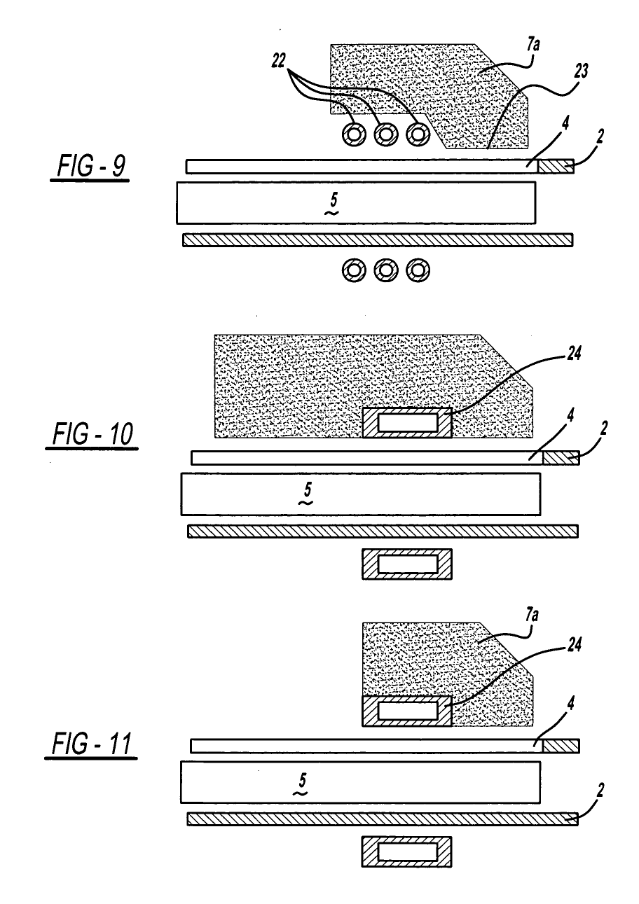

FIG. 9 gives a longitudinal cross-sectional view of an induction system with three-turn induction coil 22 and reduced magnetic bridge 7a according to the present invention. Experiments show that the parts of the magnetic body above Vee and above the coil play major role in the welding process improvement. Therefore, a simplified or reduced magnetic bridge is proposed in the embodiment of the present invention. A surface 23 of the magnetic body facing the tube edges may be profiled in order to control power distribution along the edges in the “Vee” area to improve weld quality.

FIG. 10 shows a longitudinal cross-sectional view of an induction system with a single turn induction coil 24 and incorporated magnetic bridge according to the present invention. Magnetic body may be glued to the copper plate brazed to the induction coil and cooled by conduction from the coil or by a separate water circuit.

FIG. 11 shows a longitudinal cross-sectional view of an induction system with a single turn induction coil 24 and incorporated reduced magnetic bridge according to the present invention.

The description of the invention is merely exemplary in nature and, thus, variations that do not depart from the gist of the invention are intended to be within the scope of the invention. For example, variations in cooling methods and methods of fixturing of the magnetic bridge are not to be regarded as a departure from the spirit and scope of the invention.

What is claimed is:

1. A magnetic flux guide for induction apparatus for welding tubes or closed profiles which apparatus includes an induction coil area and tube forming rolls for forming and welding a tube preform, said flux guide comprising:
an elongated magnetic body made of soft magnetic material operable for being located above the edges of a tube preform for welding by induction, said body positioned above a welding zone of the edges of the tube preform;
a system for liquid or gas cooling of the magnetic body; and
a fixture for positioning the guide above the tube preform edges.

2. The flux guide of claim 1 further comprising a wedged lower portion that faces the tube preform edges for better magnetic flux concentration in the edges.

3. The flux guide of claim 2 further comprising a profiled longitudinal surface, facing the tube preform for providing tube heating intensity control by control of the gap between the said surface and the tube edge.

4. The flux guide of claim 1 further comprising an internal cooling channel for return or one-way flow of cooling water or gas.

5. The magnetic flux guide of claim 1 that contains water or gas cooled plates made of copper, aluminum or other material with high thermal conductivity that are located inside the guide, on one side or on both sides of the magnetic body.

6. The magnetic flux guide of claim 1 that extends from the tube edge conversion point, over a Vee, and above the coil.

7. The magnetic flux guide of claim 1 wherein said guide is incorporated into the induction coil structure that provides mechanical support and cooling to the said body.

8. The magnetic flux guide of claim 1 wherein said soft magnetic material is selected from the group consisting of soft magnetic composite, ferrite, thin laminations, and combinations thereof.

9. The magnetic flux guide of claim 1 wherein said soft magnetic material further comprises a magnetic permeability of at least 15.

10. The magnetic flux guide of claim 9 wherein said soft magnetic material has a saturation flux density of ≧0.2 T.

11. The magnetic flux guide of claim 1 wherein said soft magnetic material has a service temperature of greater than 180° C.

12. The magnetic flux guide of claim 1 wherein a tapered portion of said guide extends between the forming rolls.

13. The magnetic flux guide of claim 1 that extends from the tube edge conversion point, over a Vee, above the coil, and beyond the coil.
